(19) United States
(12) Patent Application Publication
(10) Pub. No.: US 2011/0267623 A1
(43) Pub. Date: Nov. 3, 2011

(54) Multi-Wavelength Reference Microplate For Label-Independent Optical Reader

(76) Inventors: Steven R. Matejka, Beaver Dams, NY (US); Robert Adam Modavis, Painted Post, NY (US); David Andrew Pastel, Horseheads, NY (US); Jeffrey G Ulbrandt, Painted Post, NY (US)

(21) Appl. No.: 12/915,904

(22) Filed: Oct. 29, 2010

Related U.S. Application Data
(60) Provisional application No. 61/257,061, filed on Nov. 2, 2009.

(51) Int. Cl. G01N 21/47

(52) U.S. Cl. 356/446

(57) ABSTRACT

A multi-wavelength reference microplate for a label-independent optical reader is disclosed. The microplate includes a support plate that supports a plurality of reference wells. At least one of the reference wells is configured as a multi-wavelength reference well having disposed therein two or more resonant waveguide grating sections that respectively reflect two or more different reference resonant wavelengths within the light source wavelength band. Methods for making and using the microplates are also disclosed.

### CLAIMING BENEFIT OF PRIOR FILED U.S. APPLICATION

This application is a non-provisional application and claims the benefit of U.S. Provisional Application Ser. No. 61/257,061, filed on Nov. 2, 2009. The content of this document and the entire disclosure of any publication or patent document mentioned herein are incorporated by reference.

### CROSS-REFERENCE TO RELATED COPENDING APPLICATION

Commonly owned and assigned co-pending application U.S. Ser. No. 61/257058 (filed concurrently herewith) entitled “MULTI-GRATING BIOSENSOR FOR LABEL-INDEPENDENT OPTICAL READERS”.

### FIELD

The present disclosure relates to label-independent optical readers, and in particular relates to multi-wavelength microplates for such readers.

### BACKGROUND

Label-independent (LID) optical readers are used, for example, to detect a drug binding to a target molecule such as a protein. Certain types of LID optical readers measure changes in refractive index on the surface of a resonant waveguide grating (RWG) biosensor for an array of RWG biosensors. The individual RWG biosensors are located in respective wells of a microplate. Broadband light from a broadband light source is directed to each RWG biosensor. Only light whose wavelength is resonant with the RWG biosensor is strongly reflected. This reflected light is collected and spectrally analyzed to determine the resonant wavelength, which is representative of a refractive index change and thus biomolecular binding to the RWG biosensor.

Spurious changes to the refractive index of the RWG biosensor and other system effects can reduce the accuracy of the resonant wavelength measurement.

Consequently, a reference microplate can be used with standardized RWGs that produce a resonant wavelength within the optical readers' operating spectral bandwidth λ_{FWHM}, which is typically approximately 824 nm to 844 nm. However, broadband light sources can have variations (noise) that are not detected by present-day reference microplates.

### SUMMARY

An aspect of the disclosure is a multi-wavelength reference microplate for a LID optical reader having a light source with a wavelength band. The microplate includes a support plate that supports a plurality of reference wells. At least one of the reference wells is configured as a multi-wavelength reference well having disposed therein two or more RWG sections that respectively reflect two or more different reference resonant wavelengths within the light source wavelength band.

Another aspect of the disclosure is a multi-wavelength reference microplate for a LID optical reader having a light source with a wavelength band. The microplate includes a support plate that operably supports a plurality of multi-wavelength reference wells each having a RWG biosensor disposed therein that includes two or more RWG sections that respectively have two or more reference resonant wavelengths. The microplate also includes a fill material that at least partially fills each multi-wavelength reference well, with the fill material having a refractive index similar to that of water, such as of about 1.3, within the light source wavelength band.

Another aspect of the disclosure is a method of using a reference microplate with reference wells to measure multiple reference resonant wavelengths in a LID optical reader system. The method includes providing in at least one reference well two or more RWG sections each having a different reference resonant wavelength. The method also includes irradiating each of the two or more RWG sections to generate respective reflected light therefrom. The method further includes spectrally analyzing the respective reflected light to measure the two or more reference resonant wavelengths.

These and other aspects of the disclosure will be described by reference to the following written specification, claims and appended drawings.

### BRIEF DESCRIPTION OF THE DRAWINGS

A more complete understanding of the present disclosure may be had by reference to the following detailed description when taken in conjunction with the accompanying drawings, wherein:

FIG. 1 is a generalized schematic diagram of an example optical reader system suitable for use with the multi-wavelength reference microplate of the disclosure;

FIG. 2 shows an exemplary RWG biosensor array operably supported in regions or “wells” of a microplate, which in turn is held by a microplate holder;

FIG. 3 is an example plot of the resonant wavelength λ_{R} (nm) vs. position (mm) across the RWG biosensor;

FIG. 4 is a plot of the peak amplitude (photon counts) versus spectrometer pixel location, which corresponds to wavelength and illustrates how the resonant wavelength shifts;

FIG. 5 is a plot of the intensity (dB) versus wavelength (nm) for a typical superluminous diode (SLD) measured through a linear polarizer and illustrates the typical SLD spectral bandwidth λ_{FWHM}, which has fringes (ripples) when polarized;

FIG. 6 is a plot of the resonant wavelength λ_{R} as a function of time (minutes) as calculated using numerical modeling based on shifting fringes in the SLD spectrum plot of FIG. 5;

FIGS. 7A through 7C are close-up plan views of respective multi-wavelength reference wells of an example multi-wavelength reference microplate, wherein each multi-wavelength reference well has a reference RWG biosensor that includes multiple RWG sections with different resonant-wavelength reflectivities;

FIGS. 8A and 8B illustrate an example method of forming a multi-wavelength reference RWG biosensor by disposing multiple RWGs on a common substrate;

FIGS. 9A through 9C are similar to FIGS. 7A through 7C and illustrate example embodiments of multi-wavelength reference wells wherein the reference RWG biosensors have contiguous RWG sections;

FIGS. 10A through 10C illustrate a first method of forming RWG sections using a mask-based approach;

FIGS. 11A through 11D include perspective and cross-sectional views that illustrate a second method of forming contiguous RWG sections using multiple coatings to form different waveguide thicknesses that define the different RWG sections;

FIGS. 12A and 12B are cross-sectional views of an example multi-wavelength reference well of a multi-wavelength reference microplate, wherein FIG. 12B shows a multi-wavelength reference well filled with a water mimic;

FIG. 13 is similar to FIG. 3 and shows an example multi-wavelength reference microplate having m sets of multi-wavelength reference wells, with the insets A through C showing different example configurations for the multi-wavelength reference wells in the different sets;

FIG. 14 is a plot similar to FIG. 6 and shows a schematic wavelength spectrum for an SLD light source, along with the different reference resonant wavelengths λ_{RR} (dashed lines) associated with three different sets of multi-wavelength reference wells for an example multi-reference microplate such as shown in FIG. 13;

FIG. 15A is a plot of the change in wavelength noise (picometers) versus reference well number as measured on an example optical reader system having a stable broadband light source, for both a prior art reference microplate (dashed line) and the multi-wavelength reference microplate (solid line) of the present disclosure; and

FIG. 15B is the same plot as FIG. 15A, except that the optical readers system uses an unstable broadband light source, and illustrates how the multi-wavelength reference microplate (solid line) detects the light source variations while the prior art reference microplate (dashed line) does not.

### DETAILED DESCRIPTION

Reference is now made to embodiments of the disclosure, exemplary embodiments of which are illustrated in the accompanying drawings.

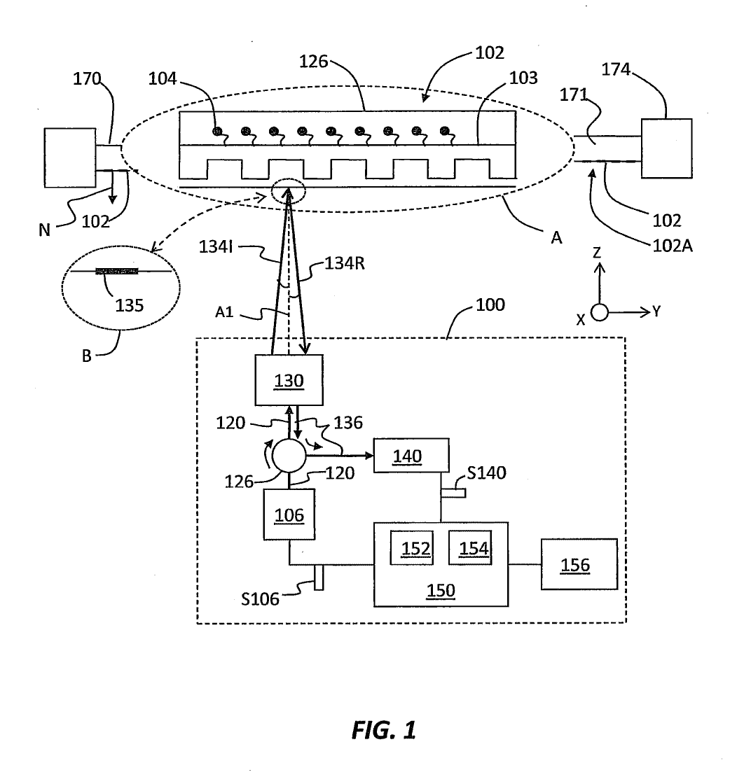

FIG. 1 is a generalized schematic diagram of an example optical reader system (“system”) 100 used to interrogate one or more RWG biosensors 102 each having a surface 103 to determine if, for example, a biological substance 104 is present on the RWG biosensor. Inset A shows a close-up of an exemplary RWG biosensor 102. System 100 is suitable for use in combination with the multi-wavelength reference microplate 170R of the disclosure as introduced and discussed in greater detail below.

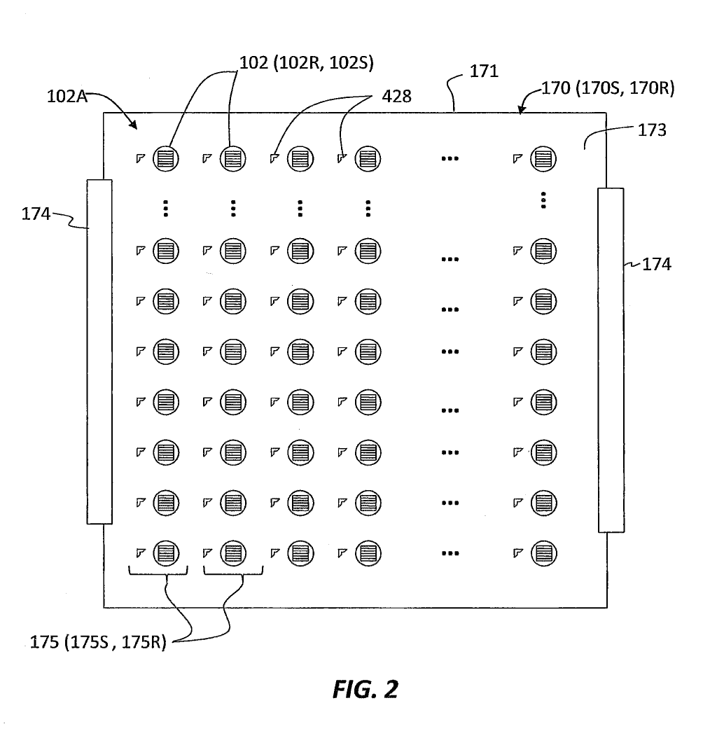

FIG. 2 is a plan view of an example microplate 170 that comprises a support plate 171 with a surface 173 having a plurality of wells 175 formed therein. An example support plate 171 has a two-part construction of an upper plate and a lower plate (not shown), as described, for example, in U.S. Patent Application Publication No. 2007/0211245, which is incorporated by reference herein.

Microplate 170 of FIG. 2 illustrates an exemplary configuration where RWG biosensors 102 are arranged in an array 102A and operably supported in wells 175. For a “sample” microplate 170S that includes actual biological samples, each well 175 contains a “sample region” 175S and a “reference region” 175R. Each well region has a resonant wavelength, generally referred to as λ_{R}. The sample or “signal” resonant wavelength of sample RWG biosensor 102S is denoted as λ_{RS} and the reference resonant wavelength of a reference RWG biosensor 102R is denoted as λ_{RR}. It is important that biological samples do not attach to the reference region 175R. Therefore, reference regions within wells 175 are biologically altered, or adjacent wells (“reference” wells 175R) will be used as shown in FIG. 2. On a reference microplate 170R, the RWG biosensors 102 are referred to as “reference RWG biosensors 102R”.

An exemplary RWG biosensor array 102A has a 4.5 mm pitch for RWG biosensors 102 that are 2 mm square, and includes 16 RWG biosensors per column and 24 RWG biosensors in each row. In embodiments, fiducials 428 can be used to position, align, or both, the microplate 170 in system 100. A microplate holder 174 is also shown holding microplate 170. Many different types of plate holders can be used as microplate holder 174. Here again, microplate 170 can be the actual sample microplate 170S or a reference microplate 170R used to calibrate or troubleshoot system 100.

With reference again to FIG. 1, system 100 includes a light source 106 that generates light 120. Light source 106 may include one or more of a lamp, laser, diode, filters, attenuators, and like devices or combinations thereof An example light source 106 includes a broad-band light source such as a super luminescent diode (SLD), discussed in greater detail below. Light 120 from light source 106 is directed by a coupling device 126 (e.g., a circulator, optical switch, fiber splitter or like device) to an optical system 130 that has an associated optical axis A1 and that transforms light 120 into an incident optical beam 134I, which forms a light spot 135 at RWG biosensor 102 (see inset B). Incident optical beam 134I (and thus light spot 135) is scanned over the RWG biosensor 102 by either a scanning operation of scanning optical system 130 or by the movement of microplate 170 via microplate holder 174.

Incident optical beam 134I reflects from RWG biosensor 102, thereby forming a reflected optical beam 134R. Reflected optical beam 134R is received by optical system 130 and light 136 therefrom (hereinafter, “guided light signal”) is directed by coupling device 126 to a spectrometer unit 140, which generates an electrical signal S140 representative of the spectra of the reflected optical beam. In embodiments, a controller 150 having a processor unit (“processor”) 152 and a memory unit (“memory”) 154 then receives electrical signal S140 and stores in the memory the raw spectral data, which is a function of a position (and possibly time) on RWG biosensor 102. Thereafter, processor 152 analyzes the raw spectral data based on instructions stored therein or in memory 152.

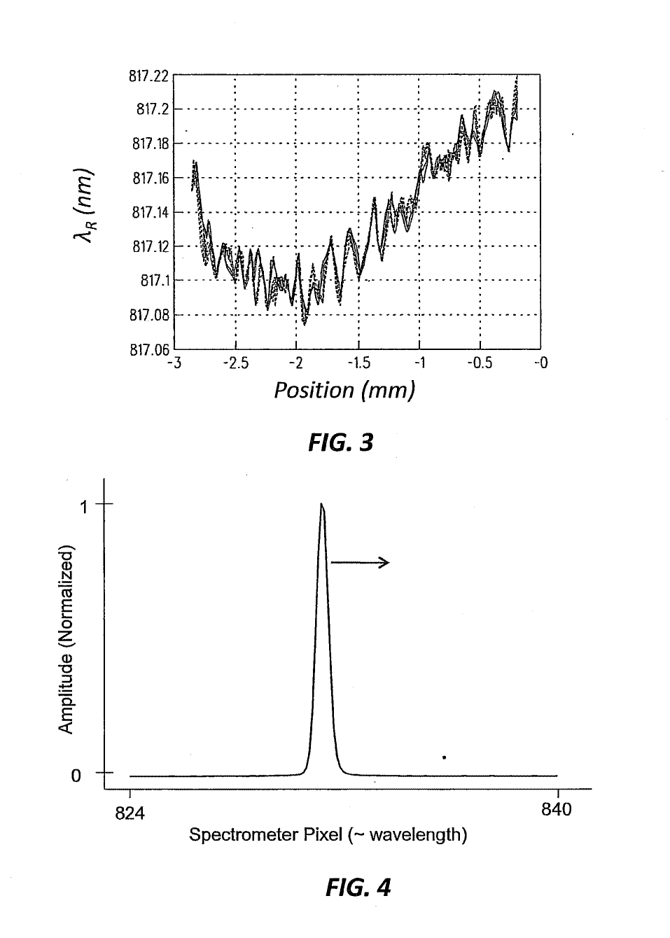

The result is a spatial map of resonant wavelength (λ_{R}) data such as shown in FIG. 3, which shows the calculated resonance wavelength centroid as a function of the position of the scanning spot across the sensor for a number of different scans. The variation of the resonance wavelength λ_{R} indicates if a chemical or biological reaction happened for a specific RWG biosensor 102. In embodiments, controller 150 includes or is operably connected to a display unit 156 that displays measurement information such as spectra plots, resonant wavelength plots, and other measurement results, and system status and performance parameters. In embodiments, spectra can be processed immediately so that only the resonant wavelengths (as calculated, for example, as the respective centroids of measured spectra) are stored in memory 154.

Example RWG biosensors 102 make use of changes in the refractive index at sensor surface 103 that affect the waveguide coupling properties of incident optical beam 134I and reflected optical beam 134R to enable label-free detection of biological substance 104 (e.g., cell, molecule, protein, drug, chemical compound, nucleic acid, peptide, carbohydrate) on the RWG biosensor. Biological substance 104 may be located within a bulk fluid deposited on RWG biosensor surface 103, and the presence of this biological substance alters the index of refraction at the RWG biosensor surface.

To detect biological substance 104, RWG biosensor 102 is probed with incident optical beam 134I, and reflected optical beam 134R is received at spectrometer unit 140. Controller 150 is configured (e.g., processor 152 is programmed) to determine if there are any changes (e.g., 1 part per million) in the RWG biosensor refractive index caused by the presence of biological substance 104. In embodiments, RWG biosensor surface 103 can be coated with, for example, biochemical compounds (not shown) that only allow surface attachment of specific complementary biological substances 104, thereby enabling RWG biosensor 102 to be both highly sensitive and highly specific. In this way, system 100 and RWG biosensor 102 can be used to detect a wide variety of biological substances 104. Likewise, RWG biosensor 102 can be used to detect the movements or changes in cells immobilized to RWG biosensor surface 103, for example, when the cells move relative to the RWG biosensor or when they incorporate or eject material, a refractive index change occurs.

If multiple RWG biosensors 102 are operably supported as an array 102A, then they can be used to enable high-throughput drug or chemical screening studies. For a more detailed discussion about the detection of a biological substance 104 (or a biomolecular binding event) using scanning optical reader systems, reference is made to U.S. patent application Ser. No. 11/027,547. Other optical reader systems are described in U.S. Pat. No. 7,424,187 and U.S. Patent Application Publications No. 2006/0205058 and 2007/0202543.

The most commonly used technique for measuring biochemical or cell assay events occurring on RWG biosensors 102 is spectral interrogation. Spectral interrogation entails illuminating RWG biosensor 102 with a multi-wavelength or broadband beam of light (incident optical beam 134I), collecting the reflected light (reflected optical beam 134R), and analyzing the reflected spectrum with spectrometer unit 140. An exemplary reflection spectrum from an example spectrometer unit 140 is shown in FIG. 4, where the “peak amplitude” is the number of photon counts as determined by an analog-to-digital (A/D) converter in the spectrometer. The resonance is covered by about 10 pixels and the wavelength range is from about 824 nm to 840 nm. When chemical binding occurs at RWG biosensor surface 103, the resonance shifts slightly in wavelength, as indicated by the arrow, and such shift is detected by spectrometer unit 140.

### Light Source Noise

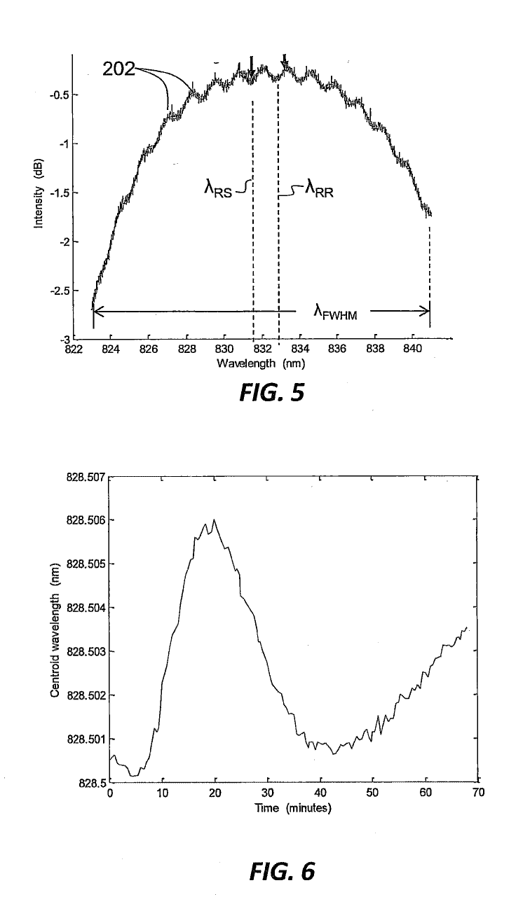

As discussed above, in an example of system 100, light source 106 employs a broadband light source such as an SLD. FIG. 5 is a plot of the intensity (dB) versus wavelength (nm) for a typical SLD as measured through a linear polarizer and illustrates the typical SLD waveform (spectrum), which has fringes (ripples) 202 when polarized. Fringes 202 have a period of about 1.27 nm. The actual fringe period of a light source will vary based on its design and the polarizer used. Example locations of the signal resonant wavelength λ_{RS} and reference resonant wavelength λ_{RR} are indicated in FIG. 5, and are typically a few nm apart. Light source 106 has a full-width half-maximum (FWHM) spectral bandwidth λ_{FWHM}.

If fringes 202 shift over time, the power level of the waveguide resonant wavelength is altered and the resulting signal resonant wavelength λ_{RS} reported by the LID detection system shifts. FIG. 6 is a plot of the signal resonant wavelength λ_{RS} as a function of time (minutes) as calculated using numerical modeling based on shifting fringes 202. The plot of FIG. 6 shows how the shifting fringes cause a shift in the signal resonant wavelength λ_{RS} over time. The signal and reference resonant wavelengths λ_{RS} and λ_{RR} are affected differently, causing additional noise to the resulting measurement, and possibly masking any biomolecular binding signal.

Consequently, reference microplate 170R of the present disclosure is a “multi-wavelength reference microplate” configured to verify the stability of an SLD-based light source 106. Multi-wavelength reference microplate 170R has at least one and preferably multiple multi-wavelength reference wells 175R that each provide multiple reflected wavelengths in a manner that approximates the sample microplate 170S, that matches one half the fringe period of the SLD light source, or both. Multi-wavelength reference microplate 170R provides the capability to sample multiple wavelengths within the operating wavelength spectral bandwidth λ_{FWHM} of light source 106 to more accurately measure or otherwise characterize the optical reader system's noise performance. In embodiments, all of the reference wells 175R of multi-wavelength microplate 170R are multi-wavelength reference wells, while in other embodiments, the multi-wavelength microplate includes one or more but not all multi-wavelength reference wells.

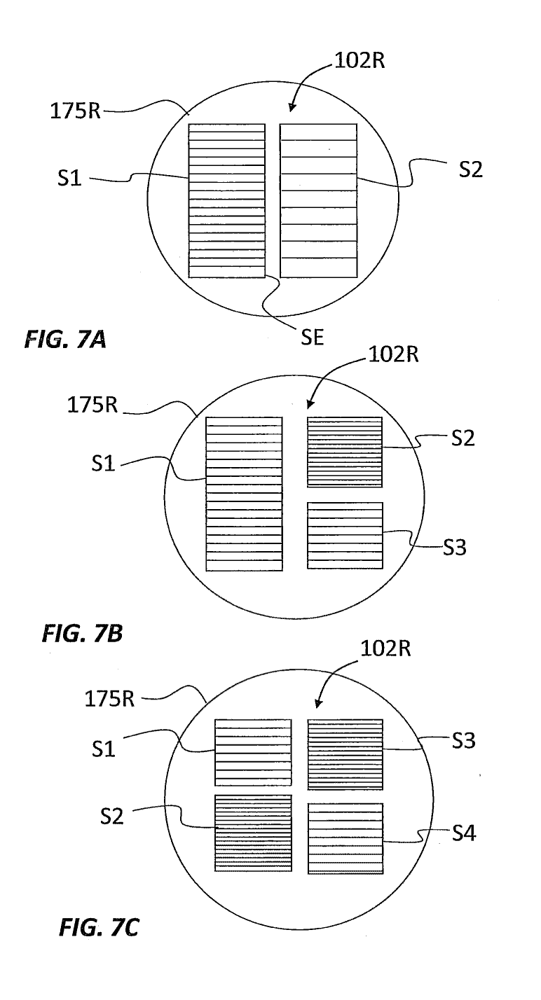

FIGS. 7A through 7C are close-up plan views of respective multi-wavelength reference wells 175R of an example multi-wavelength reference microplate 170R. Each multi-wavelength reference well 175R has a reference RWG biosensor 102R that includes multiple (n≧2) RWG sections Sₙ having different reference resonant-wavelengths λ_{RRn}. FIGS. 7A through 7C illustrate respective multi-wavelength reference wells 175R having two, three, and four RWG sections Sₙ (labeled as S₁, S₂, S₃ and S₄) having different respective reference resonance wavelengths λ_{RR1}, λ_{RR2}, λ_{RR3} and λ_{RR4}. The number n of RWG sections Sₙ employed in a given reference RWG biosensor 102R depends on how many reference resonance wavelengths λ_{RRn} are needed to adequately sample the wavelength spectral bandwidth λ_{FWHM} of light source 106. RWG sections Sₙ are shown by way of an example as being spaced apart, thereby providing edges SE that can be used to identify which RWG grating section is being interrogated by incident beam 134I. In embodiments, the RWG sections Sₙ are spaced apart a distance equal to or greater than the size (diameter) of light spot 135. For example, if light spot 135 has a diameter of 100 λm, an example spacing between adjacent RWG sections Sₙ is 200 λm.

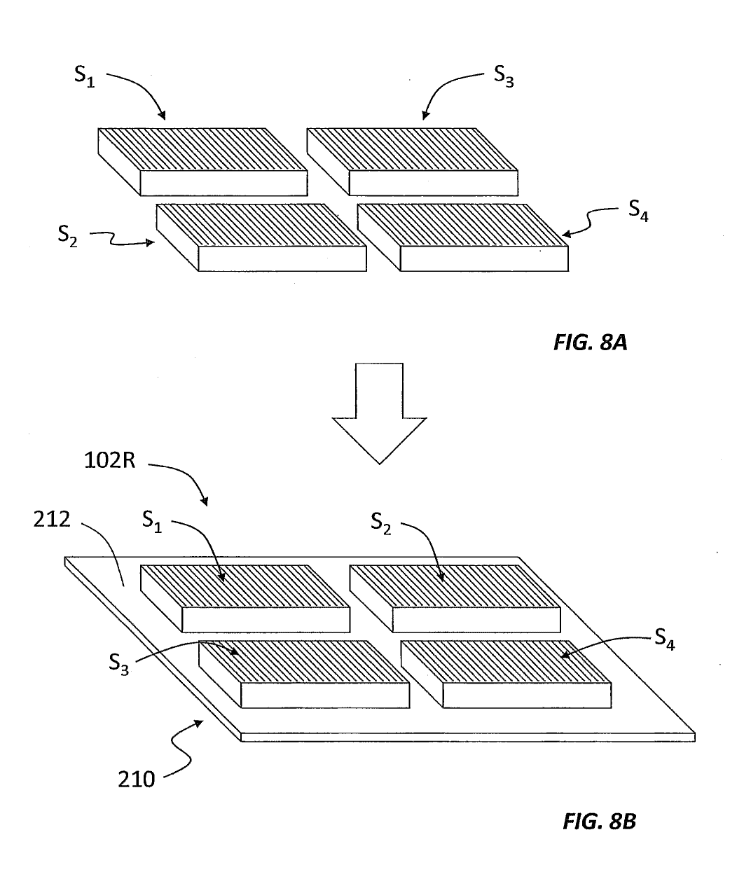

In embodiments, RWG sections Sₙ are formed separately to have different grating periods and thus different reference resonant wavelengths λ_{RRn}. The separate RWG sections Sₙ are then disposed on an upper surface 212 of a support substrate 210, as illustrated in FIGS. 8A and 8B, thereby forming a multi-segment reference RWG biosensor 102R. The multi-segment reference RWG biosensor 102R is then disposed in a well 175 to form a multi-wavelength reference well 175R.

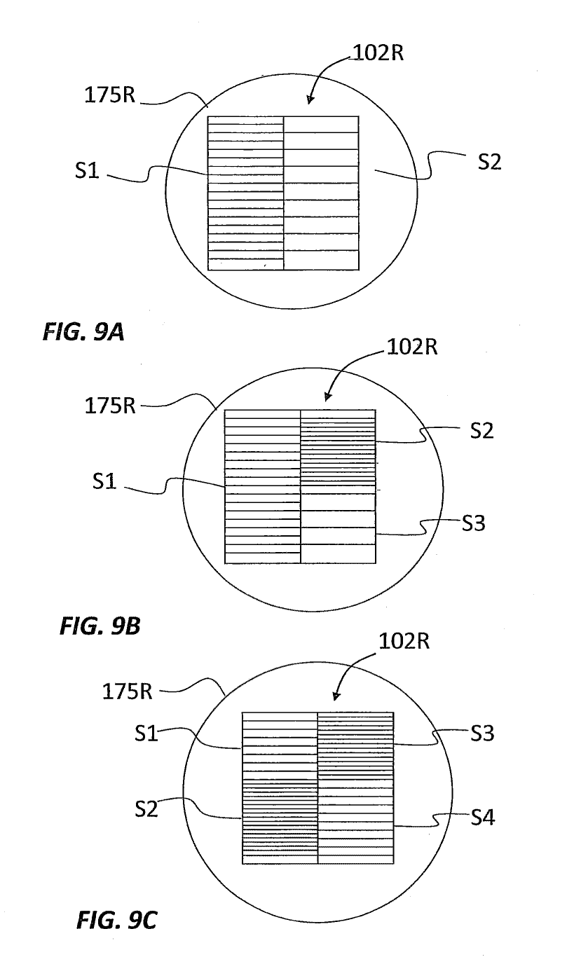

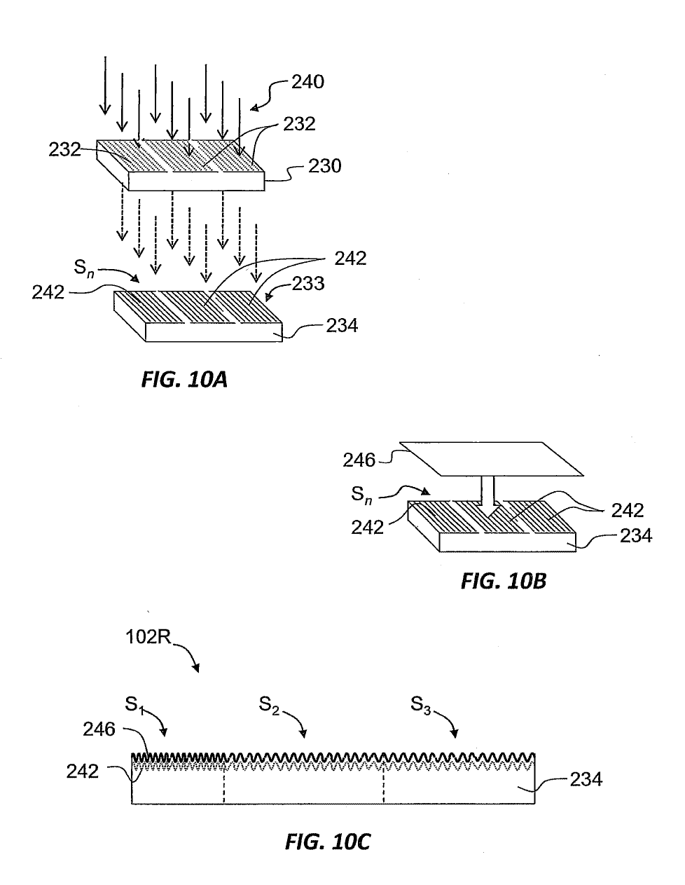

FIGS. 9A through 9C are similar to FIGS. 7A through 7C and illustrate example embodiments of multi-wavelength reference wells 175R wherein reference RWG biosensors 102R have contiguous RWG sections Sₙ. In one case, the contiguous grating sections Sₙ are formed at the same time using, for example, standard photolithographic techniques. Here, with reference to FIGS. 10A through 10C, a single mask 230 having multiple regions 232 with different grating periodicities is irradiated with light 240 to form contiguous sections Sₙ of gratings 242 on a photosensitive surface 233 of substrate 234. Contiguous grating sections Sₙ are shown slightly separated for the sake of illustration. Photosensitive surface 233 may include, for example, a layer of photoresist. This mask exposure is followed by applying a single coating 246 over RWG sections Sₙ on substrate surface 233 to form reference RWG biosensor 102R shown in FIG. 10C in cross-sectional view, with three contiguous RWG sections S₁, S₂ and S₃ demarcated by dashed lines. Note that coating 246 is substantially conformal to the underlying gratings 242.

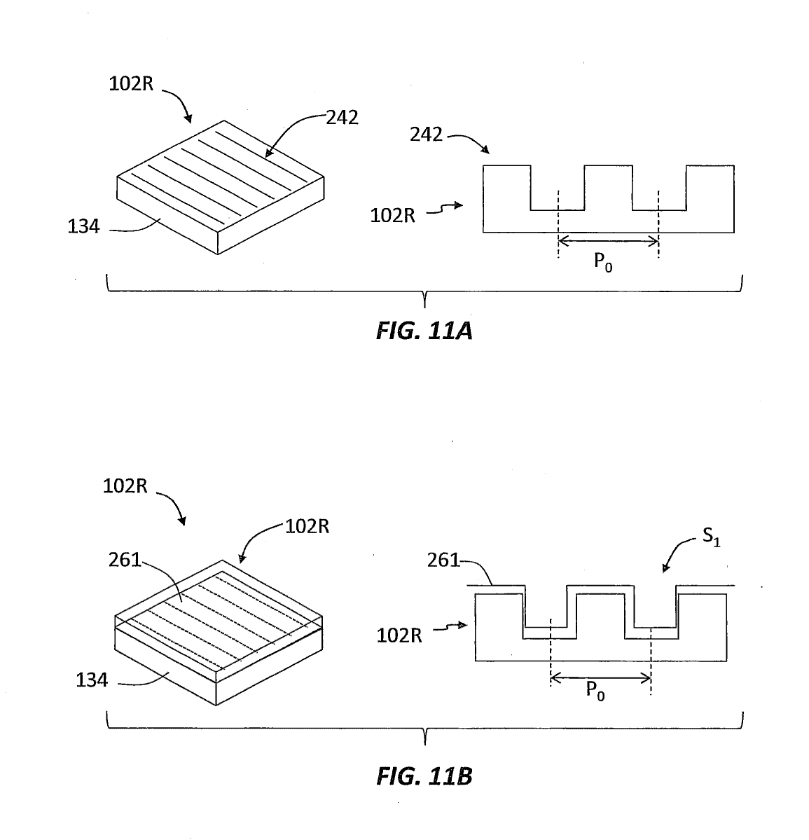

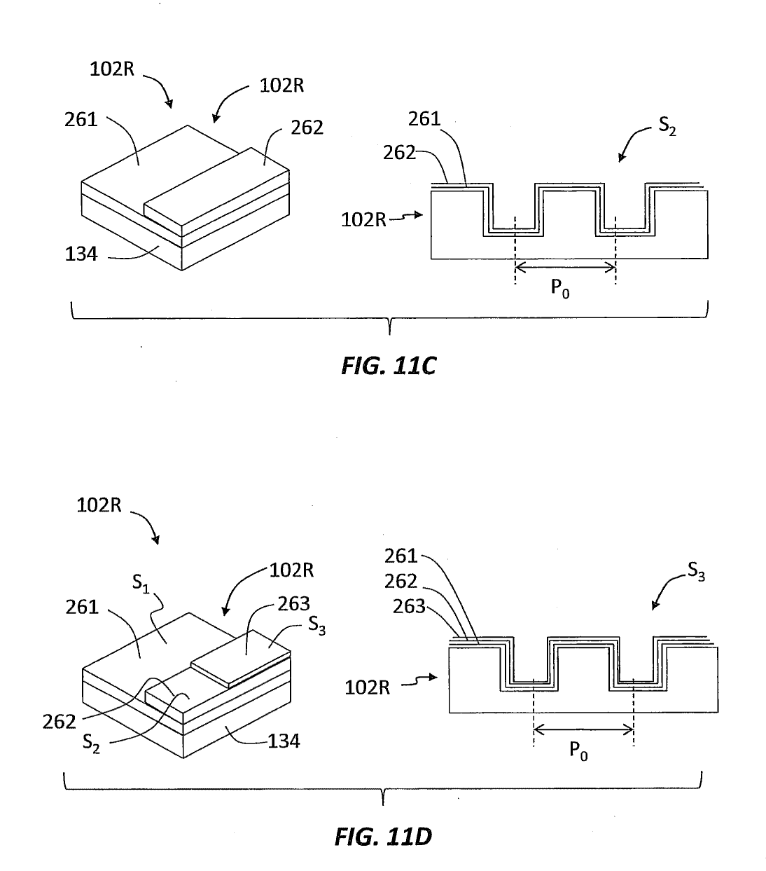

FIGS. 11A through 11D illustrate another example method of forming contiguous RWG sections Sₙ that employs multiple coatings that changes the grating thickness. With reference first to FIG. 11A, an initial RWG biosensor 102R having a substrate 234 with a grating 242 of period P₀ and a reference resonant wavelength λ_{RR0} is provided. Then, with reference to FIG. 11B, the reference RWG biosensor 102R of FIG. 11A is covered with a first coating 261 designed to increase the waveguide thickness without substantially altering the waveguide period P₀, thus shifting the reference resonant wavelength from λ_{RR0} to wavelength λ_{RR1} within the light source spectral bandwidth λ_{FWHM}. In embodiments, period P₀ can be chosen so that the reference resonant wavelength λ_{RR0} is already within the light source spectral bandwidth λ_{FWHM}.

Then, with reference to FIG. 11C, a portion of first coating 261 can be coated with a second coating 262 designed to locally alter the grating thickness and thus to reflect a reference resonant wavelength λ_{RR2} within the light source spectral bandwidth λ_{FWHM}.

Then, with reference to FIG. 11D, a portion of second coating 262 can be coated with a third coating 263 designed to locally alter the grating thickness and thus to reflect a reference resonant wavelength λ_{RR3} within the light source spectral bandwidth λ_{FWHM}. This process results in the formation of a multi-segment reference RWG biosensor 102R having three RWG sections S₁, S₂ and S₃ that respectively have reference resonant wavelengths λ_{RR1}, λ_{RR2} and λ_{RR3} all within light source spectral bandwidth λ_{FWHM}. Thus, two or more RWG sections Sₙ can be formed in this manner The cross-sectional views of FIG. 11C through 11D are taken through the multiply coated sections.

Note that the grating period P₀ is on the order of hundreds of nanometers while the thickness increases due to the coatings are on the order of 5 nm to 10 nm. The period P₀ does not change due to addition of the coatings, thought there is a slight changed in the duty cycle, which has a negligible effect on the performance of the multi-segment reference RWG biosensor 102R.

In embodiments, layers 261, 262, and 263 can be applied using known selective mask-based deposition techniques. In embodiments, coatings 261, 262, and 263 can comprise niobia.

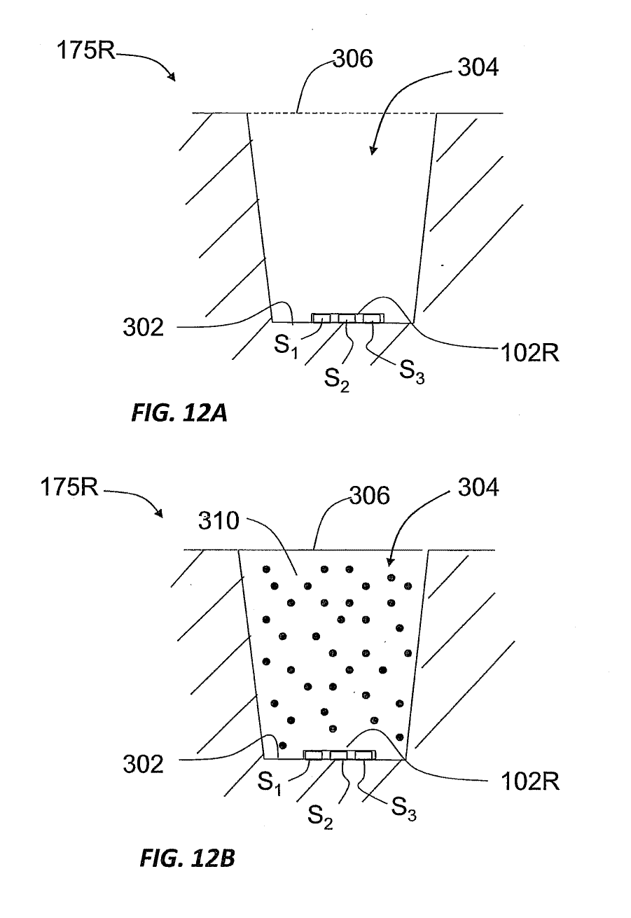

FIGS. 12A and 12B are cross-sectional views of an example multi-wavelength reference well 175R of a multi-wavelength reference microplate 170R. Multi-wavelength reference well 175R includes a bottom 302, an interior 304 and an open top 306. FIG. 12A shows a reference RWG biosensor 102R disposed at well bottom 302, with interior 304 filled with air.

Since the sample microplate 170S will have its sample wells 175S filled with water, multi-wavelength reference wells 175R must also be filled with either water or a material that mimics water by having substantially the same refractive index (e.g., of about 1.3) within light source spectral bandwidth λ_{FWHM}. The use of distilled water to fill multi-wavelength reference wells 175R is an option, though it is generally not preferred because water may cause RWG biosensors to degrade (e.g., delaminate) over time. Distilled water also evaporates, and can spill out of the reference wells 175R if reference microplate 170R is not carefully handled or the wells not sealed.

With reference to FIG. 12B, in an example embodiment, multi-wavelength reference wells 175R are at least partially filled (and in an example embodiment, completely filled) with a fill material 310 that has a refractive index and thermal properties similar to that of water. An exemplary fill material 310 is solid at room temperature and is not easily perturbed by the environment. In an example embodiment, fill material 310 comprises an elastomer, an optical epoxy, or a combination thereof. Use of elastomers in reference microplates is discussed in the aforementioned U.S. Patent Application Publication No. 2007/0211245.

An example elastomer fill material 310 suitable for use in filling multi-wavelength reference wells 175R is sold under the brand name of Sylgard-184® elastomer, available from the Dow Corning Corporation, Midland, Mich. The Sylgard-184® elastomer has the following properties/characteristics as provided in Table 1:

TABLE 1
Sylgard-184 ® elastomer properties

| | |
|---|---|
| Physical Form | Liquid |
| Color: | Colorless |
| Odor: | Some odor |
| Specific Gravity @ 25° C.: | 1.05 |
| Viscosity: | 5000 cSt or 3900 cpsi |
| Boiling Point: | >35° C./95° F. |
| One or two parts: | 2 |
| Durometer: | 50 A |
| Working Time RT: | >2 hours |
| Room Temp Cure Time: | 48 hours |
| Heat Cure Time: | 45 min @ 100 C. |
| Thermal Conductivity | 0.18 (watts/meter- K) |
| Refractive Index: | about 1.41 to 1.42 |
| dn/dT: | about 450 ppm/degree C. |

It is noted here that any fill material 310 that is known or is subsequently developed that has properties and characteristics substantially the same as that of the Sylgard-184™ elastomer is or will be suitable for use in the present disclosure.

Fill material 310 is added to interior 306 of multi-wavelength reference wells 175R either manually using a positive displacement pipette or by an automated filling process. Multi-wavelength reference microplate 170R is then allowed to cure for approximately two days at room temperature, after which time the elastomer fill material 310 within the multi-wavelength reference wells 175R has fully cured and is ready for use.

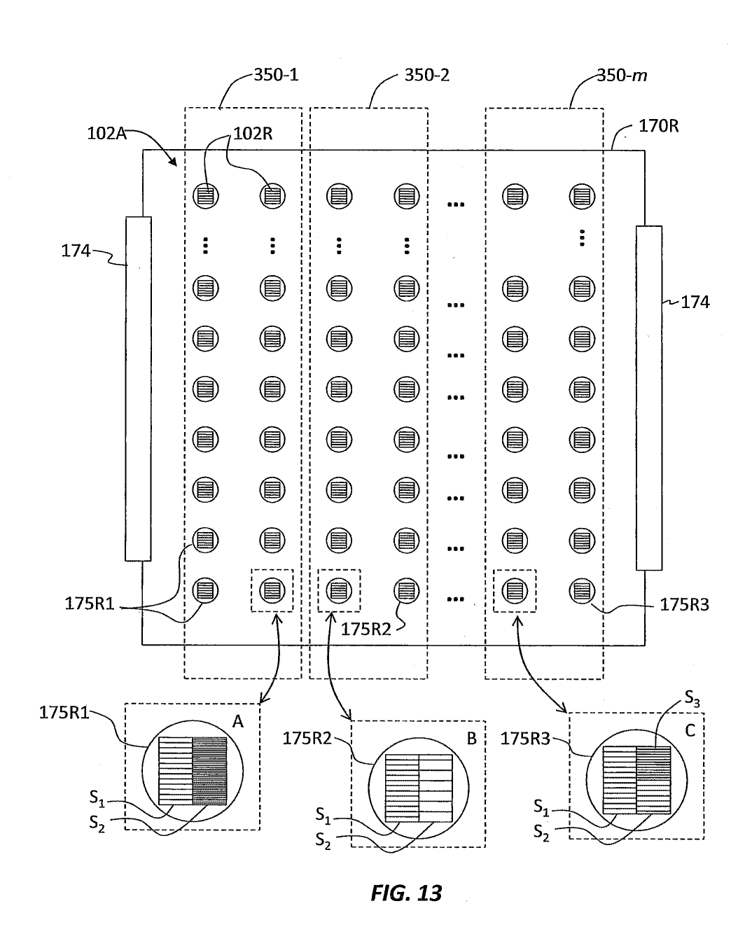

FIG. 13 is similar to FIG. 3 and shows an example multi-wavelength reference microplate 170R having m sets 350 (e.g., 350-1, 350-2, . . . 350-m) of multi-wavelength reference wells 175R. The different sets 350 of multi-wavelength reference wells 175R respectively contain multi-segment reference RWG biosensors 102R having different reference resonant wavelengths λ_{RR}, namely for set 350-1: λ_{RR1A}, λ_{RR1B}, . . . ; for set 350-2: λ_{RR2A}, λ_{RR2B}, . . . ; and for set 350-3: λ_{RRmA}, λ_{RRmB}, . . . .

Consider by way of example a multi-wavelength reference microplate 170R having three different multi-wavelength reference well sets 350-1, 350-2 and 350-3. The first set 350-1 includes multi-wavelength reference wells 175R1 having multi-segment reference RWG biosensors 102R with two sections S₁ and S₂ configured to reflect reference wavelengths λ_{RR1A}=825 nm and λ_{RR2A}=830 nm (see inset A). The second set 350-2 includes multi-wavelength reference wells 175R2 having multi-segment reference RWG gratings 102R again with two sections S₁ and S₂ configured to reflect reference wavelengths λ_{RR2A}=834.5 nm and λ_{RR2B}=837 nm (see inset B). The third set 350-3 includes multi-wavelength reference wells 175R3 having multi-segment reference RWG gratings 102R with three sections S₁, S₂ and S₃ configured to reflect reference wavelengths λ_{RR3A}=840 nm, λ_{RR3B}=842 nm and λ_{RR3C}=844 nm (see inset C).

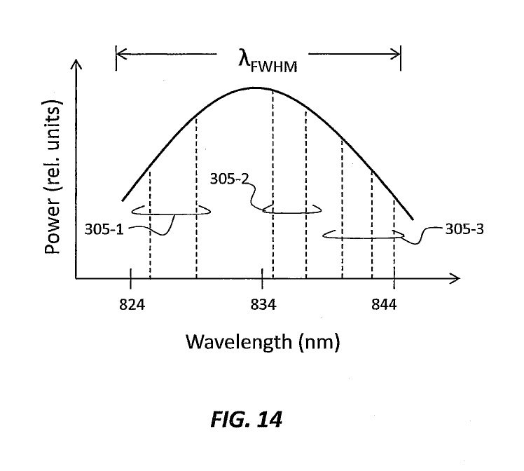

The result is a multi-wavelength reference microplate 170R that provides wavelength information at multiple wavelengths within the broadband light source spectral bandwidth λ_{FWHM}. FIG. 14 is a plot similar to FIG. 6 and shows a schematic example wavelength spectrum for an SLD light source 106. The plot of FIG. 14 shows the seven different reference wavelengths λ_{RR} reflected by the different reference wells 175R of the example reference microplate 170R of FIG. 13. The number m of reference well sets 350 can be selected to provide as complete a wavelength coverage as needed or desired.

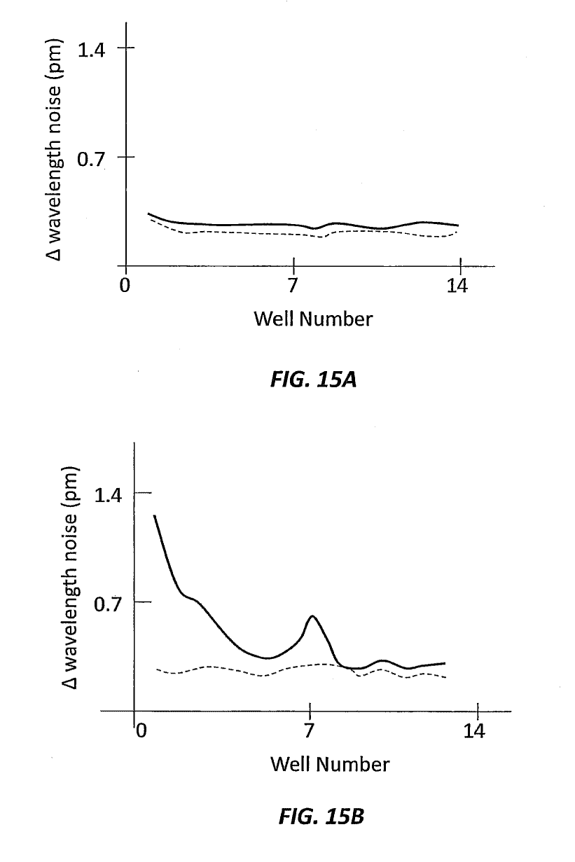

FIG. 15A is a plot of the change in wavelength noise (picometers) versus reference well number as measured on an example optical reader system 100 having a stable broadband light source 106. The “noise” is the difference between the measured signals resonant wavelength λ_{RS} versus the measured reference resonant wavelength λ_{RR}. The standard (prior art) reference microplate was used (dashed line) and the multi-wavelength reference microplate 170R of the present disclosure was also used (solid line). For a stable light source 106, the two types of microplates give essentially the same constant reading for the change in wavelength noise

FIG. 15B is a plot similar to FIG. 15A, except that an unstable broadband light source 106 was used in the optical reader system. The plot of FIG. 15B reveals that the prior art reference microplate shows substantially no change in the wavelength noise, while the multi-wavelength reference microplate 170R of the present disclosure shows a significant change in the wavelength noise due, as one would expect, to variations in the (polarized) light source output spectrum. Thus, the prior art reference microplate is unable to detect spectral variations in light source 106 that cause measurement noise in the optical reader system.

Multi-wavelength reference microplates 170R can be employed by end-users to ensure system performance prior to running an assay, or use them as a reader control during an assay. The multi-wavelength reference microplates 170R provide a more realistic simulation of the customer assay then the prior art reference microplates. It is also noted that multi-wavelength reference plates 170R simplify field support efforts by providing multi-wavelength (and up to full spectrum) verification of the optical reader system in a single reference microplate. Currently, field support personnel must carry multiple microplates and additional metrology equipment (notch filters, etc) if they need to fully evaluate the optical reader's optical spectrum.

It will be apparent to those skilled in the art that various modifications to the preferred embodiment of the disclosure as described herein can be made without departing from the scope of the disclosure as defined in the appended claims. Thus, the disclosure covers the modifications and variations provided they come within the scope of the appended claims and the equivalents thereto.

What is claimed is:

1. A multi-wavelength reference microplate for a label-independent optical reader, the reader having a light source with a wavelength band, comprising:
a support plate that supports a plurality of reference wells, at least one reference well being configured as a multi-wavelength reference well having disposed therein two or more resonant waveguide grating (RWG) sections that respectively reflect two or more different reference resonant wavelengths within the light source wavelength band.

2. The microplate of claim 1, wherein all the reference wells are configured as multi-wavelength reference wells.

3. The microplate of claim 1, wherein the two or more RWG sections are contiguous.

4. The microplate of claim 1, wherein the two or more RWG sections are spaced apart from each other.

5. The microplate of claim 4, wherein the two or more RWG sections are disposed on a common substrate.

6. The microplate of claim 1, wherein the two or more RWG sections have respective two or more coatings of different thicknesses that respectively define two or more different grating periods that in turn respectively define the two or more different reference resonant wavelengths.

7. The microplate of claim 1, wherein the microplate includes two or more sets of multi-wavelength reference wells, with the multi-wavelength reference wells within each set having the same two or more reference resonant wavelengths and the different sets having different two or more reference resonant wavelengths.

8. The microplate of claim 1, wherein each multi-wavelength reference well is filled with a fill material having a refractive index of about 1.3 within the light source wavelength band.

9. The microplate of claim 8, wherein the fill material comprises an elastomer, an optical epoxy, or a combination thereof

10. A multi-wavelength reference microplate for a label-independent optical reader, the reader having a light source with a wavelength band, comprising:
a support plate that supports a plurality of multi-wavelength reference wells each having a reference resonant waveguide grating (RWG) biosensor disposed therein that includes two or more RWG sections that respectively have two or more reference resonant wavelengths; and
a fill material that at least partially fills each multi-wavelength reference well, wherein the fill material has a refractive index of about 1.3 within the light source wavelength band.

11. The multi-wavelength reference microplate of claim 10, wherein the fill material comprises an elastomer, an optical epoxy, or a combination thereof

12. The multi-wavelength reference microplate of claim 10, wherein the two or more RWG sections are contiguous.

13. The multi-wavelength reference microplate of claim 10, wherein the two or more RWG sections are spaced apart from each other.

14. The multi-wavelength reference microplate of claim 10, wherein the two or more RWG sections include respective coatings having different thicknesses.

15. A method of using a reference microplate with reference wells to measure multiple reference resonant wavelengths in a label-independent optical reader system, comprising:
providing in at least one reference well two or more resonant waveguide grating (RWG) sections each having a different reference resonant wavelength;
irradiating each of the two or more RWG sections to generate respective reflected light therefrom; and
spectrally analyzing the respective reflected light to measure the two or more reference resonant wavelengths.

16. The method of claim 15, wherein the two or more RWG sections are contiguous.

17. The method of claim 15, wherein the two or more RWG sections are spaced apart.

18. The method of claim 15, wherein the two or more RWG sections are separate sections on a common substrate.

19. The method of claim 15, further comprising filling the at least one reference well with a fill material having a refractive index of about 1.3 within the light source wavelength band, wherein the fill material comprises an elastomer, an optical epoxy, or a combination thereof.

20. The method of claim 15, further comprising defining the two or more RWG sections by:
providing a single grating with a single grating period; and
providing different coating thicknesses in different sections to form two or more grating periods in the two or more RWG sections.
